(19) United States
(12) Patent Application Publication
(10) Pub. No.: US 2012/0086601 A1
(43) Pub. Date: Apr. 12, 2012

(54) MICROWAVE ANTENNA SYSTEM

(75) Inventors: Jae Seung Lee, Ann Arbor, MI (US); Paul Donald Schmalenberg, Ann Arbor, MI (US)

(73) Assignee: Toyota Motor Engineering & Manufacturing North America, Inc., Erlanger, KY (US)

(21) Appl. No.: 12/900,565

(22) Filed: Oct. 8, 2010

(51) Int. Cl. H01Q 3/00

(52) U.S. Cl. 342/372

(57) ABSTRACT

A microwave antenna system having a plurality of antenna elements arranged in an array having two spaced ends. A first phase shifter is electrically connected to a first group of at least two adjacent antenna elements at one end of the array to control the signal phase in that first group. Likewise, a second phase shifter is electrically connected to a second group of at least two adjacent array elements at the other end of the array to control the signal phase in the second group. Individual phase shifters are electrically connected to individual middle antenna elements for at least several of the middle antenna elements between the first and second groups.

### BACKGROUND OF THE INVENTION

I. Firm of the Invention

The present invention relates generally to antennas and, more particularly, to a microwave antenna system.

Description of Related Art

A phased array antenna is oftentimes used to electronically scan a radar or microwave beam. Such microwave antenna systems are used in many different applications, including automotive applications.

These previously known phased array microwave antenna systems include a plurality of antenna elements that are linearly arranged from one end and to the other and in which the antenna elements are equidistantly spaced apart from each other. In order to control the direction of the antenna scan, phase shifters are employed to modify the phase of the incoming received signals so that the signals combine in the desired direction of the antenna system.

One approach to controlling the phase shift in the array elements is to provide a phase shifter for every single element in the array. Such a design gives near ideal performance to control the direction of the radar beam.

A disadvantage, however, of providing a phase shifter for every element in a phased array antenna is that phase shifters are relatively expensive. Consequently, providing a phase shifter for every element in the array dramatically increases not only the cost, but also the size, of the transceiver module for the radar system. In many types of systems, for example automotive systems, it is difficult to justify the cost of individual phase shifters for each array element.

In one prior design, a single phase shifter was connected to each pair of adjacent antenna elements thus effectively reducing the number of required phase shifters for the antenna system by one half. This approach, however, disadvantageously resulted in the generation of grating lobes for the received microwave signal. Such grating lobes cause targets outside the field of view to appear as if they are actually inside of the field of view and are known as ghost targets. These ghost targets cannot be distinguished from the real target and, as a result, the scannable area of the phased array is reduced.

### SUMMARY OF THE PRESENT INVENTION

The present invention provides a microwave antenna system which overcomes the above-mentioned disadvantages of the previously known antenna systems.

In brief, the microwave antenna system of the present invention comprises a phased array having a plurality of antenna elements linearly arranged from one end and to a second end. A phase shifter is electrically connected to a first group of at least two, and preferably four, antenna elements at one end of the array to control the signal phase of that first group. Similarly, a second phase shifter is electrically connected to a second group of at least two, and preferably four, adjacent antenna elements at the other end of the array to control the signal phase in the second group of antenna elements. Consequently, assuming that the first and second groups each comprise four antenna elements, the present invention effectively eliminates six phase shifters.

Preferably, a single phase shifter is also connected to a third group of at least two array elements immediately adjacent the first group and, similarly, a single phase shifter is connected to a fourth group of at least two array elements immediately adjacent the second group of array elements thus effectively reducing at least two more phase shifters from the overall antenna system. The remaining middle antenna elements each have their own individual phase shifter.

In practice, the provision of at least two groups of array elements, and preferably four groups of array elements at the ends of the array, provides effective beam steering while maintaining the grating lobes below acceptable thresholds. The overall performance of the antenna may be further improved by amplitude weighting of the signals received from the various antenna elements. For example, the amplification of the signals received from the antenna elements may be gradually reduced from the central antenna elements and to the first and second group of antenna elements.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view illustrating a preferred embodiment of the invention; and

FIG. 2 is a graph illustrating a modification of the present invention.

### DETAILED DESCRIPTION OF A PREFERRED EMBODIMENT OF THE PRESENT INVENTION

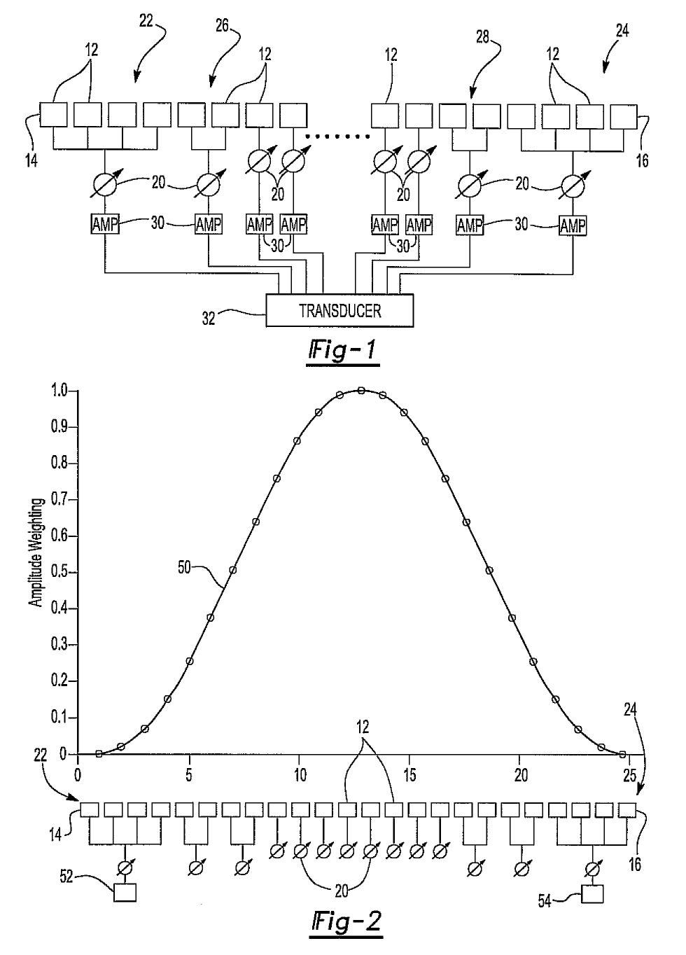

With reference first to FIG. 1, a diagrammatic view of a preferred embodiment of a microwave antenna system 10 according to the present invention is shown. The antenna system 10 includes a plurality of antenna elements 12 which are linearly arranged in an array from one end 14 and to a second end 16. The antenna elements 12, furthermore, are each substantially identical to each other and are equidistantly spaced apart from each other.

The actual number of antenna elements 12 in the antenna array will vary from one antenna system and to the next. Increasing the number of antenna elements 12 increases the accuracy of the antenna direction, and vice versa.

In order to control the beam direction, a plurality of phase shifters 20 are associated with the microwave antenna 10 to control the signal phase of the various antenna elements 12. Unlike the previously known microwave antenna systems, however, at least two, and preferably four antenna elements 12 form a first group 22 adjacent the first end 14 of the antenna array. A single phase shifter 20, furthermore, is electrically connected to all of the antenna elements 12 in the first group 22 so that the phase shift in all of the antenna elements 12 in the first group 22 is the same.

Similarly, at least two and preferably four antenna elements 12 adjacent the second end 16 of the antenna array are also electrically connected to a single phase shifter 20. This phase shifter controls the signal phase in all of the elements 12 in the second group 24 to be the same.

Still referring to FIG. 1, preferably a third group 26 of at least two antenna elements 12 immediately adjacent the first group 12 are also electrically connected to a single phase shifter 20 which controls the phase shift for all of the antenna elements 12 in the third group 26. Similarly, a single phase shifter 20 controls the phase shifts in a fourth group 28 of at least two antenna elements 12 adjacent the second group 24. The signal phase of the middle antenna elements 12, i.e. the antenna elements 12 between the third group 26 and fourth group 28, is controlled by an individual phase shifter 20 connected to each of these middle antenna elements 12.

In the conventional fashion, the outputs from the first group 22, second group 24, third group 26, and fourth group 28 of the antenna elements, as well as the middle antenna elements, are each amplified by their individual amplifier 30. The outputs from the amplifiers 30 are then coupled as an input signals to a microwave transceiver 32 for processing and display in the conventional fashion.

Consequently, it can be seen that, assuming that four antenna elements 12 are in both the first group 22 and second group 24 and that two antenna elements are in both the third group 26 and fourth group 28 of antenna elements, the required number of phase shifters 20 as well as their associated amplifiers 30 is reduced by eight as opposed to a phased antenna array in which each antenna element 12 includes its own phase shifter 20 and amplifier 30. This, in turn, results in substantial savings for relatively small microwave antennas, e.g. a 24 element microwave antenna.

With reference now to FIG. 2, in order to improve the performance of the microwave antenna system 10, the signals from the various antenna elements 12 may be amplitude weighted as shown by the graph 50 in FIG. 2. For example, the signals from the middle antenna elements 12 are more highly amplified by their respective amplifiers 30 and that amplification decreases from the center of the antenna and outwardly to each end 14 and 16. Such amplitude weighting decreases the grating lobes caused by grouping the outer antenna elements 12 into the groups 22-28 by providing lower amplitude weighting for the groups of antenna elements 12.

Still referring to FIG. 2, a pair of switches 52 and 54 are optionally connected to the first and second groups 22 and 24, respectively, in order to activate or deactivate the groups 22 and 24 depending upon the switch state. For long range radar applications, the switches 52 and 54 would be closed thus connecting the antenna element groups 22 and 24 to the system which increases the gain and narrows the beam of the antenna system 10 for long range radar applications. Conversely, for medium or short range applications, the switches 52 and 54 are opened thus effectively disconnecting the first and second groups 22 and 24 from the overall microwave antenna 10. While the effective deactivation of the first and second groups 22 and 24 reduces the gain and also increases the width of the antenna beam, beam width and gain are less important for medium and short range radar applications. However, disconnection or deactivation of the first and second groups 22 and 24 of the antenna elements effectively reduces grating elements and their resulting ghosts in medium and short range radar applications.

From the foregoing, it can be seen that the present invention provides a simple and yet effective microwave antenna system having reduced cost and complexity, but without forfeiture of operational performance. Having described our invention, however, many modifications thereto will become apparent to those skilled in the art to which it pertains without deviation from the spirit of the invention as defined by the scope of the appended claims.

We claim:

1. A microwave antenna system comprising:
a plurality of antenna elements arranged in an array having two spaced ends,
a first phase shifter electrically connected to a first group of at least two adjacent antenna elements at one end of said array to control the signal phase in said first group,
a second phase shifter electrically connected to a second group of at least two adjacent antenna elements at the other end of said array to control the signal phase in said second group, and
individual phase shifters connected to individual middle antenna elements for at least several of the antenna elements between said first and second groups of antenna elements to control the signal phase in said individual middle antenna elements.

2. The microwave antenna system as defined in claim 1 where said first group comprises at least three adjacent antenna elements.

3. The microwave antenna system as defined in claim 1 and comprising a third group of at least two adjacent antenna elements adjacent said first group and a fourth group of at least two adjacent antenna elements adjacent said second group, a single phase shifter controlling said third group of antenna elements and a single phase shifter controlling the signal phase in said fourth group of antenna elements.

4. The microwave antenna system as defined in claim 1 and comprising a switch mechanism to selectively activate or deactivate said first and second groups of antenna elements.

5. The microwave antenna system as defined in claim 1 and comprising at least one amplifier to increase the signal magnitude of said middle antenna elements relative to said first and second groups of antenna elements.

6. The microwave antenna system as defined in claim 1 and comprising a plurality of signal amplifiers, one signal amplifier being operatively connected to each of at least several of said middle antenna elements.
